(19) United States
(12) Patent Application Publication
(10) Pub. No.: US 2018/0009251 A1
(43) Pub. Date: Jan. 11, 2018

(54) PRINT MEDIA

(71) Applicant: Hewlett-Packard Development Company, L.P., Fort Collins, CO (US)

(72) Inventors: Douglas Knight, San Diego, CA (US); Lokendra Pal, San Diego, CA (US); Xulong Fu, San Diego, CA (US)

(73) Assignee: Hewlett-Packard Development Comany, L.P., Fort Collins, CO (US)

(21) Appl. No.: 15/543,531

(22) PCT Filed: Apr. 30, 2015
(86) PCT No.: PCT/US15/28451

§ 371 Date: Jul. 13, 2017

(51) Int. Cl. B41M 5/00; D21H 17/67; D21H 11/00; D21H 17/28; D21H 19/12; D21H 17/00

(52) U.S. Cl. CPC B41M 5/0017; D21H 19/12; D21H 17/74; D21H 11/00; D21H 17/28; D21H 17/675

(57) ABSTRACT

The present disclosure is drawn to print media, laminated decor products, and methods of making the same. In one example, a print medium can include an open paper substrate and a multivalent metal salt treatment applied to the open paper substrate at a multivalent metal salt loading into the open paper substrate at from 0.5 gsm to 5 gsm. The open paper substrate can include wood fiber including softwood fiber, hardwood fiber, or a blend of softwood fiber and hardwood fiber; binder including starch, protein, or hydrophilic polymer; and from 20 wt % to 50 wt % of TiO₂.

### BACKGROUND

Decor paper is used to print designs for laminate flooring, countertops, and other applications where high graphical impact and high durability may be desirable. Today most decor paper prints are prepared using analog printing methods, e.g., using rotary engraved printing processes with mixed colors with printing up to four colors within one printing pass. Additionally, decor papers typically have minimum paper width of greater than about 1 meter, e.g., about 1.3 meters, which in many cases in the past, have not been practical for inkjet applications, but have been widely possible using analog printing processes.

There are several reasons that inkjet printing has become a popular way of recording images on various medium surfaces, particularly paper. Some of these reasons include low printer noise and capability of high-speed recording, particularly in the consumer printing market. In the commercial printing market, additional reasons may include reduced job turnaround time and improved competitiveness with respect to other commercial printing methods. While various print media have been used in conjunction with inkjet printing, wide format decor paper printing is a challenging print format, particularly due to the demands related to durability, image quality, and size of decor prints. As such, an inkjet printing solution suitable for the preparation of laminated decor products would be a desirable alternative to analog printing solutions.

### BRIEF DESCRIPTION OF THE DRAWINGS

FIG. 1 is a schematic cross-sectional view of a laminated decor product which includes a print medium prepared in accordance with examples of the present disclosure; and

FIG. 2 is a flow diagram representing a method of preparing a print medium or laminated decor product in accordance with examples of the present disclosure.

It should be noted that the figures are merely exemplary of several aspects of the present technology and no limitations on the scope of the present technology are intended thereby.

### DETAILED DESCRIPTION

In accordance with examples of the present disclosure, the preparation of decor products using inkjet technology can involve providing media that facilitates the generation of images that are of high image quality, as well as provide for rapid absorption of resin after printing as part of a post printing resin impregnation step. These two goals can be at odds with one another, as open paper substrates can be used to provide rapid resin absorption, but that same type of open paper substrate can lead to reduced image quality. To illustrate, typical uncoated papers can absorb a large amount of resin relatively rapidly, but they often exhibit lack of color saturation, black optical density, and/or lack of image crispness with inkjet pigmented inks. On the other hand, if a coating is used to improve these image quality deficiencies, the coating can inherently be expensive to apply, and often generate a product that exhibits dusting at the surface. This dust can cause several issues related to high volume print production, such as nozzle clogging, web press contamination, print defects, and poor media handling. To add an additional challenge, as printed media for preparing decor products is often applied to a rigid support structure, i.e. often MDF or other physical (rigid) support or board to which the media is adhered, the media may also be formulated to adequately hide the underlying support material adhered beneath the media. The print media, printed articles, and methods described herein solve some or all of these problems by crashing pigmented inks at the print surface for improvement of print quality, providing an opaque medium for hiding undesirable underlying support structures, avoiding dusting issues that may be present with other systems, and/or improving the ability of the media to quickly or efficiently absorb resin after printing.

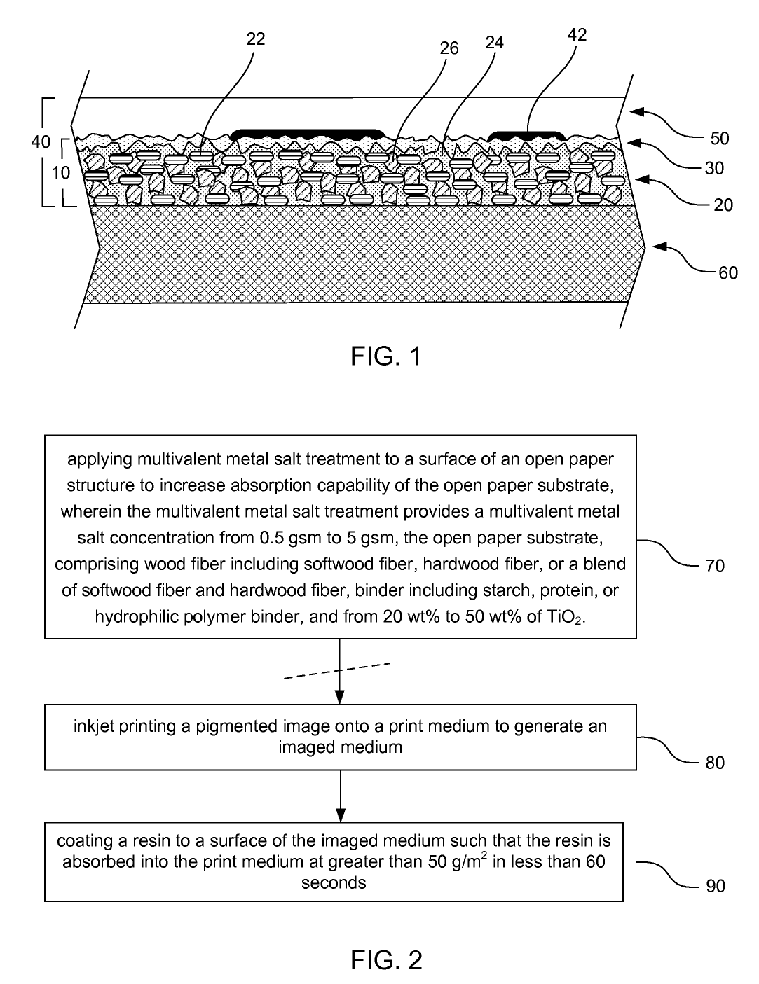

In accordance with this, the present technology is drawn to a print medium, a laminated decor product, and methods of preparing a print medium or laminated decor product. The print medium is shown in FIG. 1 as part of a laminated decor product. Specifically, the print medium is shown collectively at 10. The print medium can include an open paper substrate 20, including i) wood fiber 22 such as softwood fiber, hardwood fiber, or a blend of softwood fiber and hardwood fiber, ii) starch, protein, or hydrophilic polymer binder 24, and iii) from 20 wt % to 50 wt % of TiO₂ 26. The print medium can further include a multivalent metal salt treatment 30 applied to a surface of the open paper substrate, the multivalent metal salt treatment including from 0.5 gsm to 5 gsm of CaCl₂. It is noted that the treatment is not necessarily a coating, but rather a treatment that becomes an integral part of the open paper substrate.

In another example, a laminated decor product (shown collectively at 40) can include a print medium 10 having an open paper substrate 20 including wood fiber 22, binder 24, and 20 wt % to 50 wt % of TiO₂ 26. A multivalent metal salt treatment 30 can be applied to a surface of the open paper substrate, and the multivalent metal salt treatment can provide from 0.5 gsm to 5 gsm of multivalent metal salt, e.g., CaCl₂. In one example, the salt treatment can become an integral part of the open paper substrate, rather than a traditional coating. To the print medium, a digitally printed pigmented image 42 can be applied. Additionally, a resin 50 can be applied to one or both sides of the print medium over the pigment image. The resin coated printed image can then, in one specific example, be applied to a rigid support structure 60. The decor product as a whole can, in some examples, include the rigid support structure.

In another example, as shown in FIG. 2, a method of preparing a print medium can include applying 70 multivalent metal salt treatment to a surface of an open paper substrate to increase absorption capability of the open paper substrate, wherein the multivalent metal salt treatment provides a multivalent metal salt loading or concentration of from 0.5 gsm to 5 gsm. The open paper substrate can include wood fiber including softwood fiber, hardwood fiber, or a blend of softwood fiber and hardwood fiber; binder including starch, protein, or hydrophilic polymer binder; and from 20 wt % to 50 wt % of TiO₂. In a separate example, a method of preparing a laminated decor product, as shown in continuation below the dashed line in FIG. 2, can further include steps of inkjet printing 80 a pigmented image onto a print medium to generate an imaged medium; and coating 90 a resin to a surface of the imaged medium such that the resin is absorbed into the print medium at greater than 50 g/m² in less than 60 seconds. In further detail regarding the method and related media and products, in one specific example, heat and pressure fusing of the decor product can be carried out. In another specific example, an additional step of applying the imaged medium, on a side opposite the pigmented image, to a structural support either before or after applying the resin can be carried out. In still an additional specific example, this process can be carried out using media that is at least 1 meter in width, for wide format printing applications, e.g., printing using an HP Inkjet Web Press available from Hewlett-Packard Company.

It is noted that when discussing the present print media, laminated decor products, and/or methods, each of these discussions can be considered applicable to each of these examples, whether or not they are explicitly discussed in the context of that example. Thus, for example, in discussing examples of titanium dioxide (TiO₂) in the print medium, such examples can also be used in a method and/or related laminated decor products, and vice versa.

Turning now to the specific components and structures of the print media, several materials have been briefly described and will be described in greater detail hereinafter. For example, regarding the open paper substrate, this substrate can generally to be opaque as well as be efficiently absorptive for resin that will be ultimately applied thereto. The substrate can include, for example, a relatively high concentration of wood fiber, including softwood and/or hardwood fiber content. This will assist in keeping the substrate absorptive. Additionally, a relatively high content of TiO₂ can be used, e.g., from 20 wt % to 50 wt %, to provide a desired opacity. Other optional ingredients can also be present, provided the open paper substrate remains adequately opaque and resin absorptive. For example, the wood fibers can be present at from 30 wt % to 75 wt %, from 40 wt % to 75 wt %, or from 50 wt % to 75 wt %, keeping in mind that in some select examples, other binders or fillers (other than TiO₂) may be present in small amounts, e.g., from 0.01 wt % to 20 wt % total for other binders and fillers. The wood fibers can be hardwood fibers and/or softwood fibers, as mentioned. In one example, the softwood fibers can make up the entire wood fiber content, or alternatively, the hardwood fibers can make up the entire wood fiber content. In still other examples, a blend of any proportion of softwood to hardwood can be present, but in one example, the softwood to hardwood range can be from 99:1 to 30:70, by weight. In one specific example, a blend of softwood fiber to hardwood fiber can be from 40:60 to 60:40, or in another example, at about 50:50, by weight.

As used herein, the term “wood fiber(s)” refers to cellulosic fibers and other known paper fibers including hardwood pulps and softwood pulps as defined herein. As used herein, the term “hardwood fiber” or “hardwood pulps” refers to fibrous pulp derived from the woody substance of deciduous trees (angiosperms) such as aspen, birch, oak, beech, maple, and eucalyptus. As used herein, the term “softwood fiber” or “softwood pulps” refers to fibrous pulps derived from the woody substance of coniferous trees (gymnosperms) such as varieties of fir, spruce, and pine, as for example loblolly pine, slash pine, Colorado spruce, balsam fir and Douglas fir.

As mentioned, it is also noted that the open paper substrate can include a small amount of binder, e.g., from 0.5 wt % to 5 wt %. Suitable binders that can be used include starch, protein, hydrophilic polymer binder such as polyvinyl alcohol, or the like. Binder can be added in concentrations high enough for binding the solids together, but low enough to retain desirable resin absorption capability, e.g., at least 50 g/m² within 60 seconds.

Likewise, minor amounts of fillers (other than TiO₂) can also be present as well, provided the open paper substrate remains suitable for absorbing polymer resin, as described. To illustrate, the open paper substrate may include a small amount of internal sizing agent to help prevent the subsequently-applied surface treatment solution (multivalent metal salt treatment) from substantially soaking too much into the finished print media sheet, thereby allowing the salt to generally remain at or near the surface where it can have more effectiveness. Internal sizing agents that are suitably used for this purpose include any of those commonly used at the wet end of a paper manufacturing machine, but in this instance, agents should be selected that retain the open structure nature of the print media. For example, small amounts of rosin; rosin precipitated with alum (Al₂(SO₄)₃); abietic acid and abietic acid homologues such as neoabietic acid and levopimaric acid; stearic acid and stearic acid derivatives; ammonium zirconium carbonate; silicone and silicone-containing compounds; fluorochemicals of the general structure CF₃(CF₂)ₙR, wherein R is anionic, cationic or another functional group and n can range from 1 to 1000; starch and starch derivatives; methyl cellulose; carboxymethylcellulose (CMC); polyvinyl alcohol; alginates; waxes; wax emulsions; alkylketene dimmer (AKD); alkenyl ketene dimer emulsion (AnKD); alkyl succinic anhydride (ASA); emulsions of ASA or AKD with cationic starch; ASA incorporating alum; and/or other known internal sizing agents; and mixtures thereof. The internal sizing agents are generally used at concentration levels known to those who practice the art of paper making. For example, in some applications, the amount of internal sizing agent can be in the range of about 0.3 Kg/T of raw base paper stock to 10 Kg/T.

Once the open paper substrate is prepared with the appropriate amount of wood fiber, titanium dioxide, binder, and any other filler, sizing agents, biocides, etc., elected for use, a multivalent metal salt treatment is then applied to one or both surfaces of the open paper substrate. The multivalent metal salt treatment, as mentioned, includes a multivalent metal salt, such as CaCl₂, applied so that 0.5 gsm to 5 gsm of the multivalent metal salt is loaded into the open paper substrate after removal of the water (and in some cases, other solvents). The presence of these multivalent metal salts can provide several added advantages, including improvement of image quality, color gamut, and color richness, among other printing improvements. Furthermore, these multivalent metal salts applied as a coating to the open paper substrates can, in some cases, actually increase resin absorption (or remain about the same), which was unexpected.

In one example, the multivalent metal salt can include at least one water-soluble metal salt. Suitable metal salts include multivalent metals selected from the Group II metals, Group III metals, transitional metals, or combinations thereof. These metal salts may further include an anion selected from the group of chloride, iodide, bromide, nitrate, sulfate, sulfite, phosphate, chlorate, acetate, formate, or combinations thereof. Specific examples thereof include barium chloride, calcium chloride, calcium acetate, calcium nitrate, calcium formate, magnesium chloride, manganese sulfate, magnesium nitrate, magnesium acetate, magnesium formate, zinc chloride, zinc sulfate, zinc nitrate, zinc formate, tin chloride, tin nitrate, manganese chloride, manganese sulfate, manganese nitrate, manganese formate, aluminum sulfate, aluminum nitrate, aluminum chloride, aluminum acetate, or the like. That being described, calcium chloride (CaCl₂) has been found to work particularly well and is a cost effective choice. These metal salts may be used alone or in combinations of two or more. The metal salt concentration in the surface treatment solution can be any functional concentration, but typically are not included in the coating formulation in excess the critical saturated concentration.

In one example, the multivalent metal salt and other dry materials such as binder, additives, etc., that may be present (i.e. other than water and/or other liquid vehicle components) can be present in a coating solution from 0.1 wt % to 30 wt %, or from 5 wt % to 20 wt %, though this is not as significant since it is the final amount of salt that remains on the surface that provides the printing quality and resin absorption benefits, e.g., from 0.5 gsm to 5 gsm multivalent metal salt. Other ingredients can be present in the multivalent metal salt treatment, including other sizing agents, as mentioned. However, in one example, any additional sizing agents or other additives included can be those selected at concentrations that do not detract from resin absorption ability. For example, relatively small concentrations, e.g., from 0.1 wt % to 10 wt %, of the following sizing agents can be included along with the multivalent metal salt: starches and starch derivatives; carboxymethylcellulose (CMC); methyl cellulose; alginates; waxes; wax emulsions; alkylketene dimer (AKD); alkyl succinic anhydride (ASA); alkenyl ketene dimer emulsion (AnKD); emulsions of ASA or AKD with cationic starch; ASA incorporating alum; water-soluble polymeric materials, such as polyvinyl alcohol, gelatin, acrylamide polymers, acrylic polymers or copolymers, vinyl acetate latex, polyesters, vinylidene chloride latex, styrene-butadiene, acrylonitrile-butadiene copolymers, styrene acrylic copolymers and copolymers; and various combinations of these agents. With specific reference to starch additives, more specific examples of suitable starches that can be used include corn starch, tapioca starch, wheat starch, rice starch, sago starch and potato starch. These starch species may be unmodified starch, enzyme modified starch, thermal or thermal-chemical modified starch, or chemical modified starch. Examples of chemical modified starch are converted starches such as acid fluidity starches, oxidized starches, or pyrodextrins; derivatized starches such as hydroxyalkylated starches, cyanoethylated starch, cationic starch ethers, anionic starches, starch esters, starch grafts, or hydrophobic starches.

Paper brightness and/or whiteness of the recording medium can be modified as desired as well. As such, optical brightening agents (OBAs) or fluorescent whitening agents (FWAs) can be added as well to improve the optical appearance of the paper like brightness or whiteness. OBAs or FWAs are generally compounds that absorb ultraviolet radiant energy at 300-360 nm of the electromagnetic spectrum, and re-emit energy in the visible range mainly in the blue wavelength region (typically 420-470 nm). Again, in addition to the elements and additives discussed herein, the media can further include other additives, such as biocides, viscosity modifiers, materials for pH adjustment, sequestering agents, preservatives, and the like. Again, maintaining or even improving the ability of the print media to absorb resin is a consideration when adding these and/or other additives.

Prior to applying resin to a print medium, the medium is typically imaged with a pigment-based inkjet ink. The pigment inkjet ink can include any ingredients typically known in the inkjet arts, including pigment (e.g., self-dispersed pigment or pigment dispersed by a separate dispersing agent) and an ink vehicle (e.g., water, organic co-solvent, binders, latex, humectants, biocides, surfactants, and/or viscosity modifiers, etc.). The type of liquid vehicle and/or pigment is not particularly impactful on preparing the laminated decor product, provided the formulation as a whole and the pigment specifically performs favorably when printed in contact with the multivalent metal salt treatment. For example, pigments can be selected that will crash when contacted with the multivalent metal salt of the print medium.

Turning now to resin that can be used to coat the pigment-image, typically, the resin can include melamine-formaldehyde resin, urea-formaldehyde resin, benzoguanamine-formaldehyde resin, unsaturated polyester resin, epoxy resin, or polyurethane resin, and mixture thereof. In one specific example, Astro Mel® resins, such as Astro Mel® 3W-3A from Hexion, can be used. Astro Mel resins are partially methylated melamine resins. More specifically, Astro Mel® NW-3A is a waterborne, self-condensing resin that can crosslink hydroxy-functional polymers. Other examples of resins that can be used include Hipersine® resins from Chemisol Italia s.r.l., such as MF 138, MF 139, MF 140, MF 200, or MF 695. Still other resins can include Meldur® products (melamine formaldehyde and urea formaldehyde resins for impregnation of decorative papers) available from Melamin, e.g., Meldur® MS products, Meldur® SIS-BM, or Meldur M-8/U-T. Still other resins that can be used include Phenalloy® resins from DynaChem, e.g., Phenalloy® 2815 (phenol-formaldehyde resole resin) or Phenalloy® 2895-M (phenol-formaldehyde resin in methanol solution).

Regardless of which resin is used, a pigment-imaged print can be impregnated with the resin at a weight range from 50 gsm to 250 gsm, to provide a finished durable surface. In some examples, heat can be applied at a temperature of 120° C. to 150° C., depending on the resin selected. Pressure can also be applied at from 300 psi to 800 psi. The heat and/or pressure can be applied for a period of time typically ranging from 20 seconds to 20 minutes, or from 2 minutes to 15 minutes.

In determining “Cobb” resin absorption values in accordance with examples of the present disclosure, Astro Mel® 3W-3A from Hexion is specifically used. Thus, in further detail, Astro Mel® NW-3A (78-82 wt % solids; Brookfield viscosity of 500-900 cps; specific gravity 1.23-1.25; <0.5 wt % formaldehyde; and 10.3 lbs/gal) is applied to the print medium for 60 seconds. A Cobb resin absorption value of 100 gsm indicates 100 grams per square meter of resin is absorbed into a given print medium. In one example, the Cobb resin absorption value for the print medium can be greater than 50 gsm, greater than 100 gsm, greater than 125 gsm, greater than 150 gsm, greater than 175 gsm, greater than 200 gsm, greater than 225 gsm, or greater than 250 gsm (within 60 seconds). In accordance with this, by using the multivalent metal salt treatment compositions on the open paper substrates of the present disclosure, surprisingly, the Cobb resin absorption value can actually be increased in some examples. Typically, sizing coatings act to close up the open structure of the substrate, thus, reducing the Cobb resin absorption value. However, this has not been found to be the case with many examples of print media of the present disclosure.

It is to be understood that this disclosure is not limited to the particular process steps and materials disclosed herein because such process steps and materials may vary somewhat. It is also to be understood that the terminology used herein is used for the purpose of describing particular Examples only. The terms are not intended to be limiting because the scope of the present disclosure is intended to be limited only by the appended claims and equivalents thereof.

It is be noted that, as used in this specification and the appended claims, the singular forms “a,” “an,” and “the” include plural referents unless the context clearly dictates otherwise.

The term “decor” in the context of decor paper, laminated decor product, or the like, refers to a specific application for which the print media of the present disclosure is suitable. For example, decor papers are specialty papers that can be used to upgrade the look of structural surfaces, e.g., floors, walls, countertops, paneling, furniture, architectural panels, etc. Decor paper be printed in tile format or in rolls, and in certain specific examples, can be wide format, e.g., greater than 1 meter in printing width. Decor paper (for use in preparing laminated decor products) tend to be technically advanced and highly engineered products that provide suitable surface for decorative printing and resin saturation for durability. Laminated decor products include printed decor paper with a resin impregnated therein, e.g., melamine, polyester, mixture of urea and melamine resin, etc., and is often adhered to a rigid substrate such as a wood based substrate, e.g., particle board or MDF.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3.5, and 4 and sub-ranges such as from 1-3, from 2-4, and from 3-5, etc. Additionally, a numerical range with a lower end of “0” can include a sub-range using “0.1” as the lower end point.

### EXAMPLES

The following illustrates some examples of the present print media, laminated decor products, and methods that are presently known. However, it is to be understood that the following are only exemplary or illustrative of the application of the principles of the present compositions, methods, and systems. Numerous modifications and alternative compositions, methods, and systems may be devised by those skilled in the art without departing from the spirit and scope of the present compositions, methods, and systems. The appended claims are intended to cover such modifications and arrangements. Thus, while the present print media, laminated decor products, and methods have been described above with particularity, the following examples provide further detail in connection with what are presently deemed to be the acceptable examples.

### Example 1—Open Paper Substrates

Two different media open paper substrates were prepared in accordance with examples of the present disclosure. The two samples prepared included the following components, by solid weight content (after evaporation of water):

TABLE 1
Open paper substrate 1 (Media ID 1)

| Component | Solids Content |
|---|---|
| Softwood | 76 wt % |
| TiO₂ | 23 wt % |
| Starch Binder | 1 wt % |
| Total Solids Content | 100 wt % |

TABLE 2
Open paper substrate 2 (Media ID 2)

| Component | Solids Content |
|---|---|
| Softwood/Hardwood Blend | 68 wt % |
| (50:50 by weight) | |
| TiO₂ | 31 wt % |
| Starch Binder | 1 wt % |
| Total Solids Content | 100 wt % |

### Example 2—Black and Color Properties

Several samples from Example 1 (Tables 1 and 2) were treated with 3.5 gsm of multivalent metal salt (CaCl₂), and several others remained uncoated. To each of these samples was printed a pigmented image using an OfficeJet® 8000 printer from Hewlett Packard Company (pigment ink set). Once all of the samples were printed (some with and some without salt treatment), a portion of these samples were impregnated with resin (Astro Mel® NW-3A from Hexion), and another portion were not. All of the images were measured for Color Gamut and L*min, as well as black optical density (KOD). The results of these measurements are found in Table 3 below:

TABLE 3

| Media ID | Salt Treated | Resin Treated | Gamut | L * min | KOD |
|---|---|---|---|---|---|
| 1 | no | no | 82334 | 36.2 | 1.05 |
| 1 | yes | no | 194139 | 31.5 | 1.18 |
| 1 | no | yes | 139390 | 25.8 | 1.34 |
| 1 | yes | yes | 250903 | 20.5 | 1.53 |
| 2 | no | no | 90566 | 48.0 | 0.79 |
| 2 | yes | no | 168754 | 23.3 | 1.39 |
| 2 | no | yes | 136515 | 34.4 | 1.10 |
| 2 | yes | yes | 215775 | 17.7 | 1.63 |

As can be seen in Table 3 above, in each case, by adding salt (without or without resin), color gamut and black optical density increased compared to samples that did not include the multivalent metal salt treatment. Likewise, in cases where the media was both treated with the multivalent metal salt, and further, resin coated, the color gamut and black optical density increased the most, both on Media 1 and Media 2. Likewise, the L*min values were lowered similarly by the use of the multivalent metal salt treatment, and still further by coating with resin.

### Example 3—Cobb Resin Absorption

Samples of Example 1 (Tables 1 and 2) were coated with 3.5 gsm of multivalent metal salt (CaCl₂), and other remained uncoated. Next, all of the samples were impregnated with resin (Astro Mel® NW-3A from Hexion) using 100 ml of resin for 60 seconds to determine the 60 second Cobb resin absorption value of each sample. The samples were all 5 by 5 inches square. These samples were not imaged with ink, but in practical use, imaging can occur prior to resin coating. The results of these measurements are found in Table 4 below:

TABLE 4

| | | | | | Cobb Resin |
|---|---|---|---|---|---|
| | | | | | Absorption |
| | | Initial | Final | Resin | using a 0.01 m² |
| Media | | Weight | Weight | Weight | ring |
| ID | Salt Treated | (g) | (g) | (g) | (g/m²) |
| 1 | no | 2.93 | 4.24 | 1.31 | 131 |
| 1 | yes | 4.45 | 6.31 | 1.86 | 186 |
| 2 | no | 2.58 | 3.74 | 1.16 | 116 |
| 2 | yes | 3.62 | 6.18 | 2.56 | 256 |

As mentioned, the higher to the Cobb Resin Absorption value, the higher (and often faster) the capacity of the media to absorb resin. In each case in Table 4, resin absorption was increased when first treated with multivalent metal salt, which is contrary to the impact that a more traditional coating may have on these types of media. In fact, with Media 1, an increase (over 60 seconds) in resin absorption (g/m²) was greater than 40 wt %, i.e. 1.4 times that of the media without salt. With Media 2, an increase (over 60 seconds) in resin absorption (g/m²) was greater than 120 wt %, i.e. 2.2 times that of the media without salt. Thus, in one example, by including a multivalent metal salt treatment as described herein, a reduction of resin absorption can be avoided, i.e. no reduction in resin absorption compared to untreated media. However, in some examples, as shown in Table 4, an increase in resin absorption can be achieved in accordance with examples of the present disclosure.

While the disclosure has been described with reference to certain examples, those skilled in the art will appreciate that various modifications, changes, omissions, and substitutions can be made without departing from the spirit of the disclosure. It is intended, therefore, that the present disclosure be limited only by the scope of the following claims.

What is claimed is:

1. A print medium, comprising:
an open paper substrate, comprising:
wood fiber including softwood fiber, hardwood fiber, or a blend of softwood fiber and hardwood fiber,
binder including starch, protein, or hydrophilic polymer, and
from 20 wt % to 50 wt % of TiO₂; and
a multivalent metal salt treatment applied to the open paper substrate at a multivalent metal salt loading into the open paper substrate at from 0.5 gsm to 5 gsm.

2. The print medium of claim 1, wherein the multivalent metal salt increases the absorption capability of the open paper substrate.

3. The print medium of claim 1, wherein the multivalent metal salt treatment comprises 80 wt % to 99.9 wt % multivalent metal salt, and from 0.1 wt % to 20 wt % starch, protein, or hydrophilic polymer binder.

4. The print medium of claim 1, wherein the print medium has a Cobb resin absorption value of at least 50 g/m² with 60 seconds.

5. The print medium of claim 3, wherein the Cobb resin absorption value for the print medium is at least 40 wt % increased compared to the Cobb resin absorption value for the open paper substrate.

6. The print medium of claim 1, wherein the print medium is a decor paper having a printing width of at least 1 meter.

7. A laminated decor product, comprising:
a print medium, comprising;
an open paper substrate including wood fiber, binder, and 20 wt % to 50 wt % of TiO₂, and
a multivalent metal salt coating applied to applied to the open paper substrate at a multivalent metal salt loading into the open paper substrate at from 0.5 gsm to 5 gsm;
a digitally printed pigmented image applied to the print medium; and
a resin applied to one or both surfaces of the print medium.

8. The laminated decor product of claim 7, further comprising a structural support applied to the print medium on a side opposite the pigmented image.

9. The laminated decor product of claim 7, wherein the resin is absorbed, on average, at greater than 50 g/m² into the print medium.

10. The laminated decor product of claim 7, wherein the print medium has a Cobb resin absorption value of at least 100 g/m² over 60 seconds and is greater than the Cobb resin absorption value of the open paper substrate by at least 40 wt %.

11. The laminated decor product of claim 7, wherein the print medium has a Cobb resin absorption value of at least 180 g/m² over 60 seconds and is greater than the Cobb resin absorption value of the open paper substrate by at least 120 wt %.

12. A method of preparing a print medium or laminated decor product, comprising:
applying multivalent metal salt treatment to an open paper substrate to increase absorption capability of the open paper substrate, wherein the multivalent metal salt treatment provides a multivalent metal salt concentration to the open paper substrate at from 0.5 gsm to 5 gsm, the open paper substrate, comprising:
wood fiber including softwood fiber, hardwood fiber, or a blend of softwood fiber and hardwood fiber,
binder including starch, protein, or hydrophilic polymer binder, and
from 20 wt % to 50 wt % of TiO₂.

13. The method of claim 12, further comprising generating a laminated decor product, comprising steps of:
inkjet printing a pigmented image onto a print medium to generate an imaged medium; and
coating a resin to a surface of the imaged medium such that the resin is absorbed into the print medium at greater than 50 g/m² in less than 60 seconds.

14. The method of claim 13, further comprising applying the imaged medium, on a side opposite the pigmented image, to a structural support either before or after applying the resin.

15. The method of claim 13, further comprising applying heat and pressure to the laminated decor product.
